(19) United States
(12) Patent Application Publication
(10) Pub. No.: US 2013/0270121 A1
(43) Pub. Date: Oct. 17, 2013

(54) METHOD FOR FABRICATING COPPER NANOWIRE WITH HIGH DENSITY TWINS

(71) Applicant: NATIONAL TSING HUA UNIVERSITY, Hsinchu City (TW)

(72) Inventors: Chien-Neng LIAO, Taichung City (TW); Yu-Lun CHUEH, Hsinchu City (TW); Tsung-Cheng CHAN, Hsinchu City (TW); Yen-Miao LIN, Hsinchu City (TW)

(73) Assignee: NATIONAL TSING HUA UNIVERSITY, Hsinchu City (TW)

(21) Appl. No.: 13/779,178

(22) Filed: Feb. 27, 2013

(30) Foreign Application Priority Data
Apr. 12, 2012 (TW) 101112942

(51) Int. Cl. C25D 1/04

(52) U.S. Cl. CPC C25D 1/04; B82Y 40/00
USPC 205/76; 977/893

(57) ABSTRACT

The present invention discloses a method for fabricating a copper nanowire with high density twins, which comprises steps: providing a template having a top surface, a bottom surface and a plurality of through-holes penetrating the top surface and the bottom surface and having a diameter of smaller than 55 nm; placing the template in a copper-containing electrolyte at a low temperature lower than ambient temperature and applying a pulse current to perform an electrodeposition process to form a copper nanowire with twin structures in each through-hole. The pulse current increases the probability of stacking faults in the deposited copper ions. The low temperature operation favors formation of nucleation sites of twins. Therefore, the copper nanowire has higher density of twins. Thereby is effectively inhibited electromigration of the copper nanowire.

### FIELD OF THE INVENTION

The present invention relates to a method for fabricating a copper nanowire, particularly to a method for fabricating a copper nanowire with high density twins.

### BACKGROUND OF THE INVENTION

At present, the industry has replaced aluminum interconnects of IC with copper interconnects to overcome the problems of time lag and electromigration caused by reducing the width of interconnects. Compared with aluminum interconnects, copper interconnects have lower electrical resistivity and improve inhibition of electromigration. With IC size persistently decreased, the width of copper interconnects also needs further reducing. However, width reduction makes copper interconnects hard to sustain high current density and likely to have electromigration. Thus, elements may malfunction. Some recent researches point out that introducing twin structures into crystals of copper interconnects can solve the problem of interconnect fretting caused by copper atom migration under high density current and thus can increase the service life of copper interconnects.

U.S. Pat. No. 6,544,663 disclosed a method for fabricating a copper interconnect with twins, wherein a copper foil is fabricated by an electrodeposition method beforehand. The electrodeposition is implemented with a roller cathode, an insolvable anode and a copper sulfate electrolyte, wherein the current density is between 50 and 100 A/dm², and the copper sulfate electrolyte is at a temperature of about 50° C. The obtained copper foil has about 20% or more twin structures. Then, the copper foil is cut or etched to form interconnects. PCT patent publication No.WO00/48758 disclosed a copper interconnect and a method for fabricating the same, wherein a copper foil is fabricated firstly by an electroplating method, whereafter the copper foil is cut to obtain a plurality of copper interconnects. The electroplating method may use a direct current or an alternating current having a DC bias; the current density is between 40 and 480 A/in²; the copper sulfate electrolyte is at a temperature of 20-90° C. The resultant copper foil has twin structures or stacking faults. U.S. Pat. No. 6,670,639 disclosed a copper line and a method for fabricating the same, wherein a thin film of copper or copper alloy is fabricated by an electroplating method, a chemical vapor deposition method or a sputtering method firstly. Then, the resultant film is heat-treated to form twins, wherein the film is heated to a temperature of 180-500° C. and maintained at the temperature for 5 minutes to 10 hours, and wherein the temperature rising or descending rate is 1-5° C./min.

In the abovementioned prior arts, the twin structure is obtained either via the heat treatment method or directly via the electrodeposition method. The prior arts can indeed form twin structures. However, the density of twins is not high enough in the abovementioned prior arts. Therefore, the prior arts can only improve electromigration to a limited extent.

### SUMMARY OF THE INVENTION

The primary objective of the present invention is to overcome the problem that the conventional technologies cannot fabricate copper interconnects having sufficient twin structures to effectively improve inhibition of electromigration.

To realize the abovementioned objective, the present invention proposes a method for fabricating a copper nanowire with high density twins, which comprises steps:

providing a template having a top surface, a bottom surface, and a plurality of through-holes penetrating the top surface and the bottom surface and having a diameter smaller than 55 nm; and

placing the template in a copper-containing electrolyte and conducting an electrodeposition process with a pulse current at a low temperature lower than ambient temperature to form copper nanowires with twin structures inside the through-holes.

Compared with the conventional technologies, the method for fabricating a copper nanowire with high density twins of the present invention has the following advantages:
1. The present invention uses pulse current to implement the electrodeposition process. Therefore, a great quantity of copper ions instantly crystallizes in the through-holes. Thus, the probability of forming stacking faults in the deposited copper ions is greatly increased. Hence, the quantity and density of twins is promoted.
2. The present invention undertakes the electrodeposition process at a sub-ambient temperature. Therefore, the quantity of the nucleation sites of twins is increased. Thus, the quantity and density of twins is increased further.
3. The present invention directly forms the copper nanowires in the through-holes without additional mechanical or chemical fabrication. Therefore, the present invention has a simpler process in comparison with the conventional technologies.

### BRIEF DESCRIPTION OF THE DRAWINGS

FIGS. 1A-1D are sectional views schematically showing the process of a method for fabricating a copper nanowire with high density twins according to one embodiment of the present invention;

FIGS. 2A-2C respectively show the electron microscopy images taken in (111), (110) and (331) crystallographic planes of the product in Experiment I of the present invention;

FIG. 3 shows the electron microscopy image of the product in Comparison I of the present invention; and

FIGS. 4A-4C respectively show the electron microscopy images taken in (111), (110) and (331) crystallographic planes of the product in Experiment II of the present invention.

### DETAILED DESCRIPTION OF THE PREFERRED EMBODIMENTS

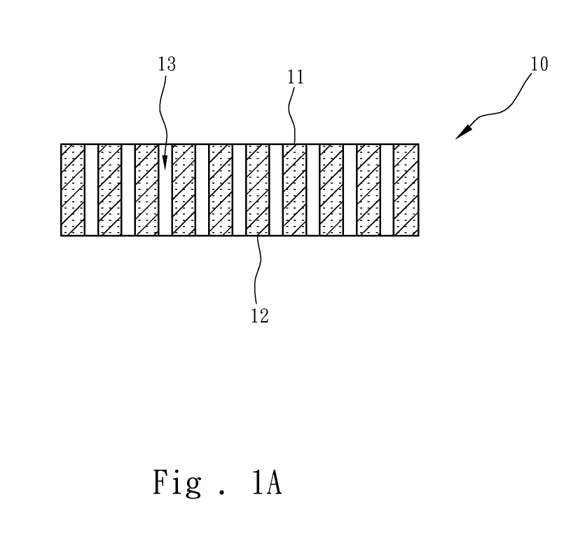

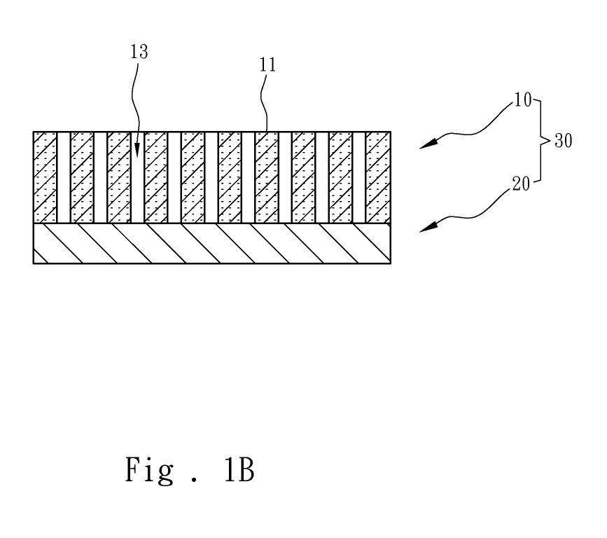

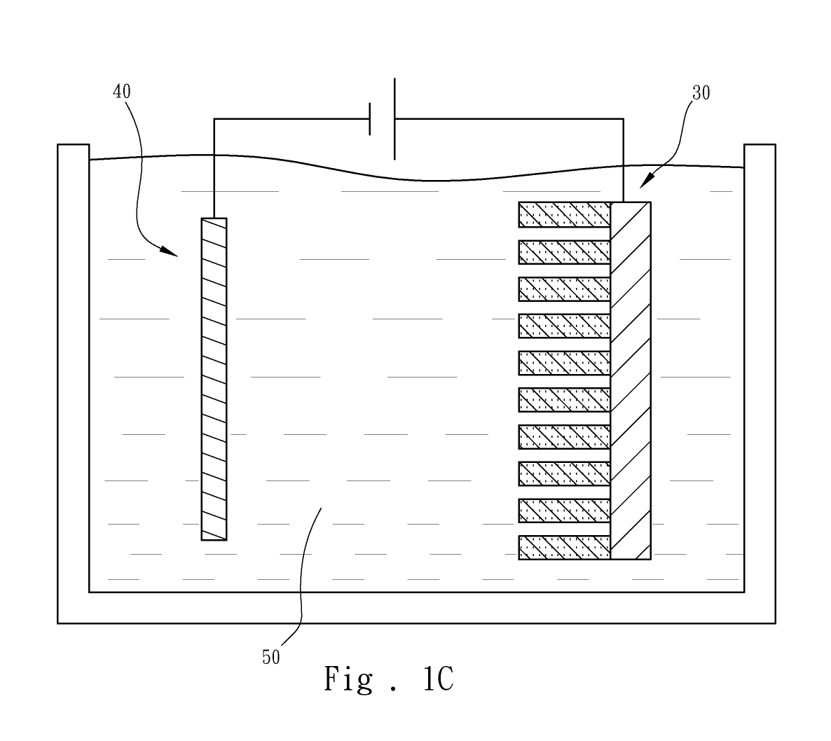

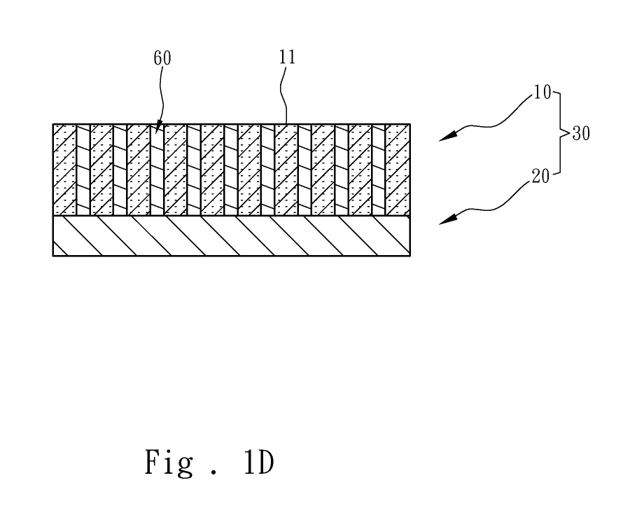

Refer to FIGS. 1A-1D for sectional views schematically showing the process of a method for fabricating a copper nanowire with high density twins according to one embodiment of the present invention. Firstly, provide a template 10 having a top surface 11, a bottom surface 12 and a plurality of through-holes 13 penetrating the top surface 11 and the bottom surface 12 and having a diameter of smaller than 55 nm, as shown in FIG. 1A. Next, join a metallic layer 20 to the bottom surface 12 of the template 10 to make the metallic layer 20 and the template 10 form a first electrode 30, as shown in FIG. 1B. The metallic layer 20 is made of a low electrical resistivity metal, such as nickel, gold, silver or copper. In this embodiment, the metallic layer 20 is preferably made of nickel. Next, place a second electrode 40 and the first electrode 30 including the template 10 with the metallic layer 20 adhering to the bottom surface 12 in a copper-containing electrolyte 50, wherein the first electrode 30 and the second electrode 40 respectively function as the cathode and the anode, as shown in FIG. 1C. In this embodiment, the electrolyte 50 is a copper sulfate solution; the second electrode 40 is made of graphite, platinum or copper.

After the first electrode 30 and the second electrode 40 have been placed in the electrolyte 50, the electrolyte 50 is cooled down to a low temperature lower than ambient temperature. The low temperature is preferably between −5 and 10° C. In this embodiment, the low temperature is between 0 and 5° C. Next, apply a pulse current to the metallic layer 20 and the second electrode 40 to make the copper ions of the electrolyte 50 deposit inside the through-holes 13 and form a copper nanowire 60 with twin structures in each through-hole 13, as shown in FIG. 1D. The pulse current has a current density of 0.4-1.8 A/cm² and a period of 0.02-0.2 seconds. The period is referred to the time interval that the pulse current is applied to the first electrode 30 and the second electrode 40.

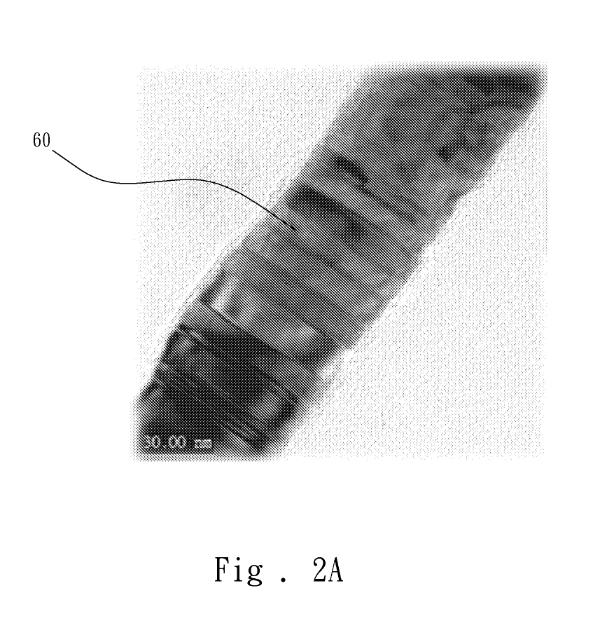

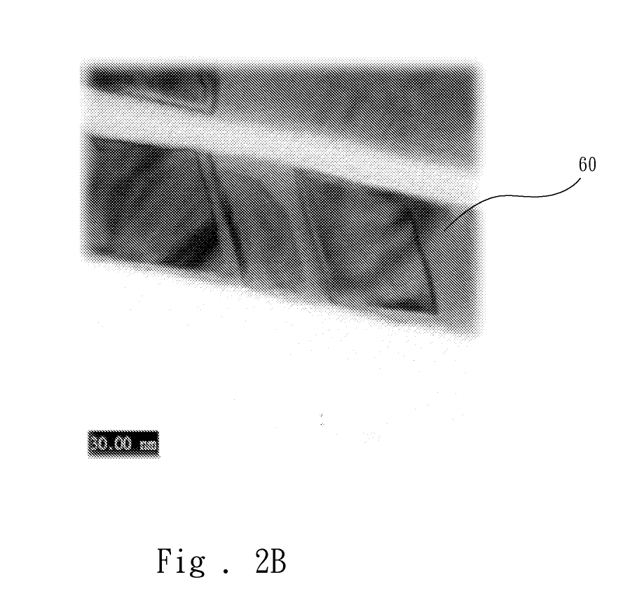

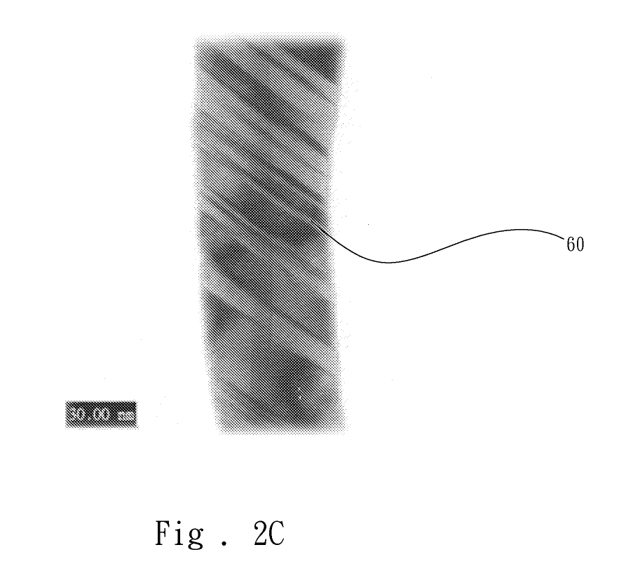

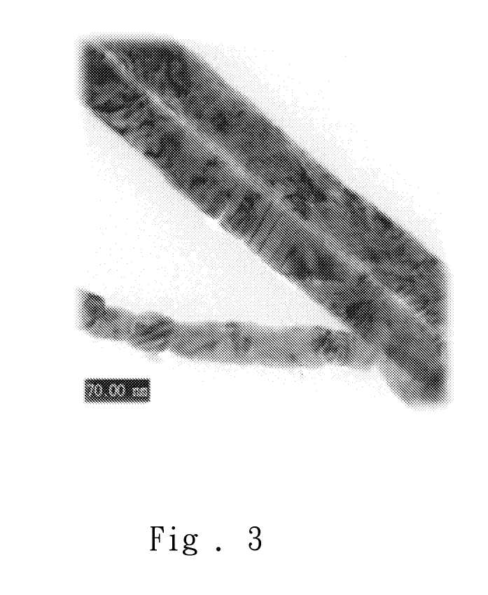

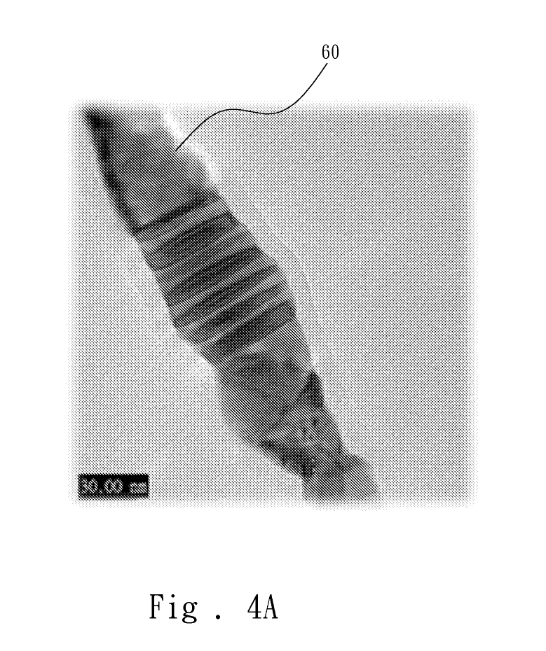

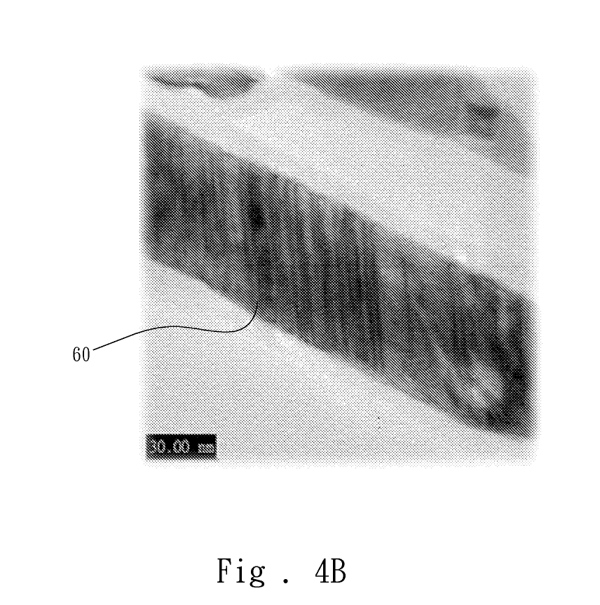

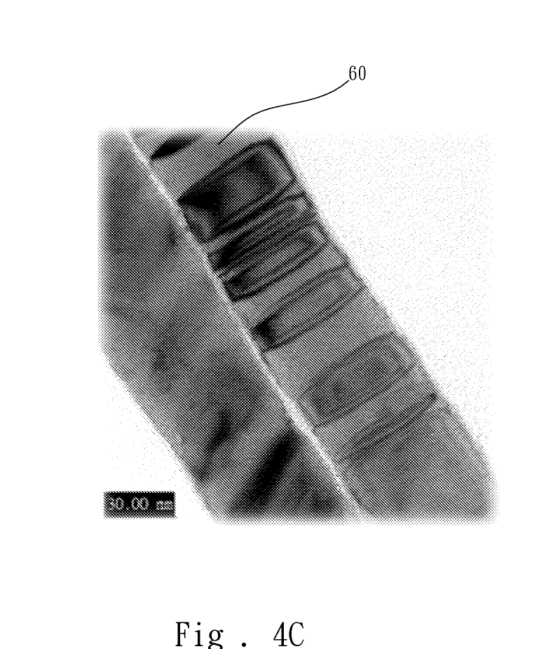

Refer to FIGS. 2A-2C respectively showing the electron microscopy images taken in (111), (110) and (331) crystallographic planes of the product in Experiment I of the present invention. Experiment I adopts a pulse current of 1.5 A/cm² with a period of 0.02 seconds and a low temperature of about −1° C. No matter from which of the (111), (110) and (331) crystallographic planes is viewed the copper nanowire 60, it is observed that there are a lot of twin structures in the copper nanowire 60. Refer to FIG. 3 showing the electron microscopy image taken in Comparison I. Similarly to Experiment I, Comparison I adopts a pulse current of 1.5 A/cm² with a period of 0.02 seconds. However, Comparison I adopts a temperature of about 25° C. It is observed in FIG. 3 that the density of twins in Comparison I is much lower than that in Experiment I. Refer to FIGS. 4A-4C respectively showing the electron microscopy images taken in (111), (110) and (331) crystallographic planes of the product in Experiment II of the present invention. Experiment II adopts a pulse current of 0.4 A/cm² with a period of 0.02 seconds and a low temperature of about 0° C. No matter from which of the (111), (110) and (331) crystallographic planes is viewed the copper nanowire 60, it is observed that there are a lot of twin structures in the copper nanowire 60.

In one embodiment, the template 10 is made of an aluminum oxide, preferably AAO (Anodic Aluminum Oxide). The method of this embodiment is described below. Firstly, provide an aluminum foil and electropolish the aluminum foil, wherein the aluminum foil and a graphite bar are placed in an electropolishing solution to respectively function as the anode and the cathode. The electropolishing solution is a mixture of two acids selected from a group consisting of phosphoric acid, acetic acid, and citric acid. Next, apply a first voltage to the aluminum foil and the graphite bar, whereby the surface of the aluminum foil achieves high flatness. Secondly, perform an anodic process on the electropolished aluminum foil, wherein the aluminum foil and another graphite bar are placed in an acidic solution to respectively function as the anode and the cathode. The acidic solution may be a solution of phosphoric acid, oxalic acid or sulfuric acid. Next, apply a second voltage to the aluminum foil and the graphite bar. Thereby, the aluminum foil forms a porous AAO board featuring self-assembled and orderly-arranged nanometric pores, and thus can function as the template 10 having the through-holes 13. Although the aluminum foil is only processed by a single cycle of anodic process in the above description, the persons skilled in the art should understand that the aluminum foil may be processed by multiple cycles of anodic processes according to the material and the fabrication parameters. The anodic process is a matured technology and will not repeat herein.

The method for fabricating a copper nanowire with high density twins of the present invention is characterized in using pulse current to perform an electrodeposition process at a low temperature lower than ambient temperature. The sub-ambient temperature operation favors formation of nucleation sites of twins and thus increases the quantity of the crystal seeds of twins. Therefore, the sub-ambient temperature operation can raise the quantity and density of twins. The pulse current makes the copper ions instantaneously deposit in the through-holes and thus increases the probability that stacking faults form in the deposited copper ions. The increased stacking faults can further promote the quantity and density of twins. Unlike the conventional technologies that the copper foil needs additional mechanical or chemical fabrication, the method of the present invention directly forms the copper nanowires in the through-holes of the template. Consequently, the method of the present invention has advantage of a simpler process.

The embodiments described above are only to exemplify the present invention but not to limit the scope of the present invention. Any equivalent modification or variation according to the spirit of the present invention is to be also included within the scope of the present invention.

What is claimed is:

1. A method for fabricating a copper nanowire with high density twins, which comprises steps:
providing a template having a top surface, a bottom surface and a plurality of through-holes penetrating the top surface and the bottom surface and having a diameter of smaller than 55 nm; and
placing the template in a copper-containing electrolyte and conducting an electrodeposition process with a pulse current at a low temperature lower than ambient temperature to form a copper nanowire with twin structures in each through-hole.

2. The method for fabricating a copper nanowire with high density twins according to claim 1, wherein the template is made of anodic aluminum oxide.

3. The method for fabricating a copper nanowire with high density twins according to claim 1, wherein the pulse current has a current density of 0.4-1.8 A/cm².

4. The method for fabricating a copper nanowire with high density twins according to claim 1, wherein the pulse current has a period of 0.02-0.2 seconds.

5. The method for fabricating a copper nanowire with high density twins according to claim 1, wherein the electrolyte is a copper sulfate solution.

6. The method for fabricating a copper nanowire with high density twins according to claim 1, wherein the low temperature is between −5 and 10° C.

7. The method for fabricating a copper nanowire with high density twins according to claim 1, wherein fabrication of the template includes steps:
providing an aluminum foil; and
performing an anodic process to make at least a portion of the aluminum foil become an anodic aluminum oxide board having the through-holes so as to obtain the template.

8. The method for fabricating a copper nanowire with high density twins according to claim 7, wherein before the anodic process, the aluminum foil is electropolished.

9. The method for fabricating a copper nanowire with high density twins according to claim 1, wherein the pulse current is applied to a metallic layer, which adheres to the bottom surface of the template, and a second electrode placed in the copper-containing electrolyte.

10. The method for fabricating a copper nanowire with high density twins according to claim 9, wherein the metallic layer is made of a low electrical resistivity metal.

11. The method for fabricating a copper nanowire with high density twins according to claim 10, wherein the low electrical resistivity metal is selected from a group consisting of nickel, gold, silver and copper.

12. The method for fabricating a copper nanowire containing high density twins according to claim 9, wherein the second electrode is made of a material selected from a group consisting of graphite, platinum and copper.
